(19) United States
(12) Patent Application Publication
(10) Pub. No.: US 2003/0114592 A1
(43) Pub. Date: Jun. 19, 2003

(54) Processes for improving stability of living polymer chain ends

(75) Inventors: Thorsten Werner Brockmann, Hilton Head, SC (US); Vijay C. Mehta, Gastonia, NC (US)

Correspondence Address: MYERS BIGEL SIBLEY & SAJOVEC, PO BOX 37428, RALEIGH, NC, 27627, US

(73) Assignee: FMC Corporation

(21) Appl. No.: 10/004,260

(22) Filed: Oct. 24, 2001

(51) Int. Cl. C08F 4/46; C08F 36/06

(52) U.S. Cl. 525/195; 525/250; 525/254; 525/364; 525/366; 526/123.1; 526/177; 526/178; 526/187; 526/335

(57) ABSTRACT

Processes for improving the thermal stability of living polymer anions are provided. The invention further improves the efficiency of subsequent functionalization and linking reactions of such living polymer anions.

### FIELD OF THE INVENTION

This invention relates to processes for improving the stability of living polymer chains and the resultant polymer compositions.

### BACKGROUND OF THE INVENTION

Alkyllithium compounds have found increasing use as anionic initiators in polymer chemistry, and as reagents in organic synthesis. Typically, alkyllithium compounds are supplied commercially in hydrocarbon solution, such as hexane or cyclohexane.

Alkyllithium compounds decompose by thermal elimination of lithium hydride, with concurrent formation of the corresponding olefin. The decomposition of normal butyllithium is illustrated in equation I.

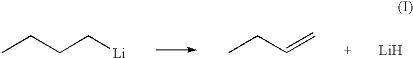

The lithium hydride is virtually insoluble in this medium, and precipitates from solution. This precipitation can cause pluggage of butyllithium pipes and transfer lines. Further, safety and environmental problems can arise when the clogged lines are cleared. In addition, the co-product of this degradation, 1-butene, is a flammable gas. Thus, the thermal stability of these alkyllithium compounds is of importance, particularly on a commercial scale.

Several factors influence the rate of thermal degradation, including: the identity of the alkyllithium compound, the concentration of the solution, the identity of the solvent, the temperature, and the nature of the impurities present, particularly alkoxides. The alkyllithium decomposition rate can be measured by the decline in the active carbon-lithium species, as determined by titration. Various titrametric methods are collected in B. J. Wakefield, Organolithium Methods, Academic Press, New York, 1988, 16-18. Thermal decomposition data for normal butyllithium (n-C₄H₉Li) and secondary butyllithium (s-C₄H₉Li) in hydrocarbon solvents is collected in the table below. The decomposition rate is shown to increase with an increase in storage temperature, and an increase in the concentration of the alkyllithium. Further, secondary butyllithium is less stable than normal butyllithium at all temperatures. For additional discussion of the thermal decomposition of alkyllithium reagents, see M. Schlosser, Organometallics in Synthesis, A Manual, John Wiley, New York, 1994, 171-173.

DECOMPOSITION RATES (% Material Lost per Day)

| | | | s-C₄H₉—Li |
|---|---|---|---|
| Storage | n-C₄H₉—Li | n-C₄H₉—Li | 10-12% m |
| Temperature (° C.) | 15-20% in hexane | 90% in hexane | isopentane |
| 0 | 0.00001 | 0.0005 | 0.003 |
| 5 | 0.0002 | 0.0011 | 0.006 |
| 10 | 0.0004 | 0.0025 | 0.012 |
| 20 | 0.0018 | 0.013 | 0.047 |
| 35 | 0.017 | 0.11 | 0.32 |

The addition of a Lewis base enhances the rate of decomposition of an alkyllithium compound. For instance, n-butyllithium is completely decomposed in tetrahydrofuran at room temperature within two hours, see H. Gilman and B. J. Gaj, J. Org. Chem., 22, 1165 (1957). The alkyllithium compound can also react with the Lewis base; this reaction is illustrated in equation II for the interaction of n-butyllithium with tetrahydrofuran.

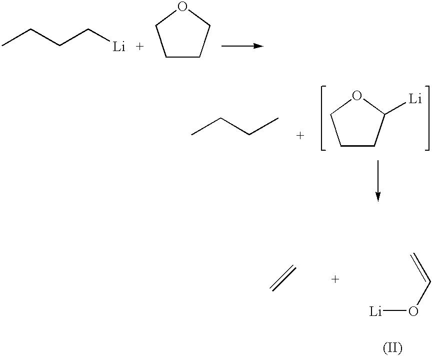

The tetrahydrofuran is initially deprotonated with the n-butyllithium, alpha to the oxygen atom, to afford n-butane. The metallated tetrahydrofuran then decomposes to ethylene and the enolate of acetaldehyde. Similar decomposition pathways exist for the interaction of other alkyllithium species with various Lewis bases. For instance, the half life of t-butyllithium in dimethoxyethane is only eleven minutes at −70° C. See J. J. Fitt and H. W. Gschwend, J. Org. Chem., 49, 209, (1984). For a further discussion of the interaction of alkyllithium compounds with Lewis bases, see H. L. Hsieh and R. P. Quirk, Anionic Polymerization, Marcel Dekker, Inc., New York, 1996, 102-103.

Thermal stability is also an issue in anionic polymerizations. The thermal stability of living chain ends during an anionic polymerization is of importance, particularly on a commercial scale. If the chain ends are labile, the living chain ends will disproportionate to the corresponding olefin and alkane. The chain ends can also decompose by thermal elimination of lithium hydride, to also afford an olefin. Further, the elimination product olefin can then add an additional equivalent of living polymer to form unwanted dimers.

For example, Fetters and Pennisi studied the thermal stability of poly(butadienyl)lithium at 75° C. (R. W. Pennisi and L. J. Fetters, Macromolecules, 21, 1094 (1988). They found that 10 wt. % of the polymer linked to form higher molecular weight products after only three hours at this temperature. After fourteen hours, 25 wt. % of the polymer had linked. See Hsieh and Quirk (H. L. Hsieh and R. P. Quirk, Anionic Polymerization, Marcel Dekker, Inc., New York, 1996, p. 177-180) for additional discussion of the thermal stability of living polymer chain ends. Thermally stable polymer chain ends are required for efficient formation of block copolymers, end group functionalization or coupling to form linear or radial (star) polymers.

U.S. Pat. No. 6,103,846 to Willis et al. is directed to a process of anionic polymerization using protected functionalized initiators of the structure R¹R²R³—Si—A—B, wherein each R¹, R², and R³ is independently selected from saturated and unsaturated aliphatic and aromatic radicals, A is a hydrocarbon bridging group containing from 1 to 25 carbon atoms, and B is an alkali metal, such as lithium. More particularly, the Willis et al. patent is directed to a polymerization process conducted in the presence of termination inhibitors selected to inhibit the reactivity of such protected functionalized initiators towards undesired side reactions. The inhibitors include metal alkyl compounds.

Willis et al. state at Column 5, lines 20 to 23, that “[i]t is unlikely that levels below one inhibitor per 10 C—Li chain ends (Metal Alkyl/C—Li Center>0.1) give a measurable level of inhibition of the side reaction with the Si—O centers.” Thus the Willis et al. patent indicates that at least 10 mol percent metal alkyl is necessary to achieve the desired reactivity inhibition. Preferred levels of the alkyl metal are stated to range from 50 mol % to 100 mol %, and the examples demonstrate the use of 100 mol % triethylaluminum (TEA).

Hsieh and Quirk, referenced above, discuss the effect of organometallic compounds of different metals with alkyllithiums. See pages 143-146 of H. L. Hsieh and R. P. Quirk, Anionic Polymerization, Marcel Dekker, Inc., New York, 1996. For example, addition of increasing amounts of dibutylmagnesium to a constant amount of sec-butyllithium in cyclohexane was reported to reduce the rate of styrene or butadiene polymerization and decrease molecular weight without significantly broadening molecular weight distribution or changing the polybutadiene microstructure. See page 145 of Hsieh and Quirk, referencing H. L Hsieh and I. W. Wang, Macromolecules, 19, 299 (1986). Thus the dibutylmagnesium slows, or inhibits, polymerization rates to better control polymer molecular weight distribution and microstructure. Generally, dibutylmagnesium is used in an amount effective to inhibit the polymerization rate to achieve this effect, or about a 1:1 molar ratio (or 100 mol % dibutylmagnesium). Even for complexes of alkyllithiums and diethylzinc, reported to increase the rate of initiation for polymerization of butadiene and styrene, diethylzinc is generally used in 1:1 molar ratios, or 100% molar %.

This inhibiting effect of an organometallic compound, such as triethylaluminum, upon polymerization reactions is illustrated by U.S. Pat. No. 5,514,753 to Ozawa et al. The Ozawa et al. patent is directed to a process for preparing block copolymers that include a non-polar block (such as a polybutadiene or polystyrene block) and a polar block (such as a poly t-butylmethacrylate block). In Ozawa et al., a non-polar block is prepared by anionically polymerizing a non-polar monomer using a suitable initiator such as butyllithium. The resultant non-polar block with a living lithium end is then reacted with a polar monomer in the presence of an organic compound containing a main group element of II or III group metals, such as triethylaluminum.

Adding triethylaluminum or other suitable agent lowers the reactivity of the carbanion at the living polymer end towards a polar monomer so as to provide the desired polymer microstructure. The amount of organic compound used is stated to range from about 0.5 to 10 mol equivalents per 1 mol equivalent of anionic polymerization initiator (or about 50 to 1000 mol %). See Column 6, lines 19-21. As further stated in the Ozawa et al. patent, “[i]f the amount is less than 0.5 mol equivalent per 1 mol of initiator, the effect might not be significant . . . ” See Column 6, lines 23-25. Thus, again the art demonstrates that such organometallic compounds are used in relatively large mol percentages in order to inhibit reactivity of the carbanion, and thus slow down polymerization rates.

### SUMMARY OF THE INVENTION

The present invention provides processes for preparing living polymer anions with enhanced thermal stability. In the invention, one or more olefinic monomers are anionically polymerized using one or more functionalized alkyllithium initiators in the presence of one or more thermal stabilizing organometallic additives. Surprisingly the inventors have found that relatively small amounts of the organometallic additive can provide unexpected benefits such as improved thermal stability of the living polymer anion, increased yields, and the like. This in turn leads to improved efficiencies in forming block copolymers, end group functionalization and coupling to form linear or radial (star) polymers. Yet the presence of the organometallic compound does not significantly adversely compromise the reactivity of the alkyllithium species as anionic polymerization initiators.

The organometallic compounds are generally used in an amount sufficient to thermally stabilize the lithiated living polymers without significantly inhibiting or compromising the reactivity of lithiated species present in the composition, such as alkyllithium initiator and/or living lithiated polymer anions. Advantageously the organometallic compound is present in an amount less than about 10 mol percent (less than 0.1 molar equivalent), based upon the amount of lithiated species present, although significantly lower levels can be effective in thermally stabilizing the living polymers.

The thermal stabilizing organometallic additives include organometallic compounds that are capable of forming ate complexes with an alkyllithium species. Exemplary organometallic compounds that are capable of forming an ate complex with an alkyllithium can be represented by the general formula MetR′ₙ, wherein:

Met is a metal, preferably selected from Group IIA, Group IIB, and Group IIIB of the Periodic Table of Elements;

each R′ is independently selected from linear or branched C₁-C₂₀ aliphatic hydrocarbons, C₂-C₂₀ cycloaliphatic hydrocarbons, C₅-C₂₀ aromatic hydrocarbons, and mixtures thereof; and

n is the valence of Met. One particularly advantageous thermal stabilizing additive is dibutylmagnesium.

The present invention also includes thermally stabilized living polymer compositions which include an organometallic additive capable of forming ate complexes with a lithiated species. The resultant living polymer anions exhibit improved thermal stability. Thus the chain ends are less labile so as to reduce disproportionation of the living chain ends to the corresponding olefin and alkane. This also can reduce the decomposition of chain ends by thermal elimination of lithium hydride, and thus reduce the formation of unwanted dimers.

### DETAILED DESCRIPTION OF THE INVENTION

Stabilizing organometallic compounds useful in accordance with the present invention include organometallic compounds capable of interacting with a lithiated species, such as an alkyllithium or a lithiated living polymer anion, to form an ate complex therewith. Advantageously the organometallic compounds are soluble in hydrocarbon solvents, but this is not required.

Organometallic compounds that are capable of forming an ate complex with a lithiated species can be represented by the general formula MetR′ₙ, wherein:

Met is a metal, preferably selected from Group IIA, Group IIB, and Group IIIB of the Periodic Table of Elements;

each R′ is independently selected from linear or branched C₁-C₂₀ aliphatic hydrocarbons, C₂-C₂₀ cycloaliphatic hydrocarbons, C₅-C₂₀ aromatic hydrocarbons, and mixtures thereof; and

n is the valence of Met.

Thus the organometallic can be described as a compound of the formula M¹R²⁰R²¹ or M²R²³R²⁴R²⁵ wherein M¹ is an element of Group IIA or Group IIB, M² is an element of Group IIIB, and each R²⁰, R²¹, R²³, R²⁴, and R²⁵ is independently selected from the group consisting of linear or branched C₁-C₂₀ aliphatic hydrocarbons, C₂-C₂₀ cycloaliphatic hydrocarbons, C₅-C₂₀ aromatic hydrocarbons, and mixtures thereof. The Group IIA and IIB elements include beryllium, magnesium, calcium, strontium, barium, radium, zinc, cadmium, and mercury. The Group IIIB elements include boron, aluminum, gallium, indium, and thallium. Exemplary organometallic compounds include without limitation diethylmagnesium, diisopropylmagnesium, dibutylmagnesium, dicyclohexylmagnesium, diphenylmagnesium, diethylzinc, dibutylzinc, diphenyl zinc, triethylaluminum, tripropylaluminum, triisopropylaluminum, tributylaluminum, trioctylaluminum, trimethylboron, triethylboron, and tributylboron and the like and mixtures thereof. As used herein, the term “butyl” includes n-butyl, sec-butyl and iso-butyl. Also as used herein the term linear or branched aliphatic hydrocarbons, cycloaliphatic hydrocarbons and aromatic hydrocarbons include functionalized hydrocarbons, including one or more sulfur, nitrogen and/or oxygen atoms.

These and other additives within the scope of this invention are commercially available or can be synthesized using commercially available starting materials using known procedures.

It has been discovered that the presence of one or more of the above described additives during anionic polymerization of olefinic monomers can improve the thermal stability of living polymer chain ends. The more stable chain ends can afford higher conversions on subsequent functionalization and/or coupling reactions. As used herein the term “thermal stability of living polymer chain ends” refers to living polymer anion compositions which exhibit at least about 75% living ends after 100 hours at 100° C. as measured using titration.

In the invention, one or more olefinic monomer(s) are anionically polymerized in the presence of one or more of the additives described above. The anionic polymerization can be conducted in an inert solvent, preferably a non-polar solvent, optionally containing an ethereal modifier, under conventional conditions, for example, at a temperature of about −30° C. to about 150° C.

The polymerization can be initiated using one or more functionalized alkyllithium initiators. Exemplary functionalized alkyllithium initiators useful in the present invention include compounds of the formula

Li—Qₙ—Z—T—(A—R₁₀R₁₁R₁₂)ₘ

and

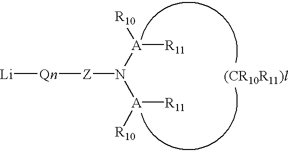

wherein:

Q is a saturated or unsaturated hydrocarbyl group derived by incorporation of one or more conjugated diene hydrocarbons, one or more alkenylaromatic compounds, or mixtures of one or more dienes with one or more alkenylaromatic compounds into the M-Z linkage;

n is from 0 to 5;

Z is a branched or straight chain hydrocarbon connecting group which contains 3-25 carbon atoms, optionally substituted with C₅-C₂₅ aryl or substituted C₅-C₂₅ aryl;

T is selected from the group consisting of oxygen, sulfur, and nitrogen groups and mixtures thereof;

(A—R₁₀R₁₁R₁₂)ₘ is a protecting group in which A is an element selected from Group IVa of the Periodic Table of the Elements, and R₁₀, R₁₁, and R₁₂ are each independently selected from the group consisting of hydrogen, C₁-C₁₅ alkyl, substituted C₁-C₁₅ alkyl, C₅-C₂₅ aryl, substituted C₅-C₂₅ aryl, C₅-C₁₂ cycloalkyl and substituted C₅-C₁₂ cycloalkyl;

l is an integer from 1 to 7; and

m is 1 when T is oxygen or sulfur, and 2 when T is nitrogen.

Examples of functionalized alkyllithium compounds include, but are not limited to, 3-(t-butyldimethylsilyloxy)-1-propyllithium, 3-(t-butyldimethyl-silyloxy)-2-methyl-1-propyllithium, 3-(t-butyldimethylsilyloxy)-2,2-dimethyl-1-propyllithium, 4-(t-butyldimethylsilyloxy) -1-butyllithium, 5-(t-butyldimethyl-silyloxy)-1-pentyllithium, 6-(t-butyldimethylsilyloxy) -1-hexyllithium, 8-(t-butyldimethylsilyloxy)-1-octyllithium, 3-(t-butyldiphenylsilyloxy) -1-propyllithium, 3-(t-butyldiphenylylsiloxy)-2-methyl-1-propyllithium, 3-(t-butyldiphenylsilyloxy)-2,2-dimethyl-1-propyllithium, 6-(t-butyldiphenylsilyloxy) -1-hexyllithium, 3-(triisopropylsilyloxy)-1-propyllithium, 3-(trimethylsilyloxy)-2,2-dimethyl-1-propyllithium, 3-(triethylsilyloxy)-2,2-dimethyl-1-propyllithium, 3-(1,1-dimethylethoxy)-1-propyllithium, 3-(1,1-dimethylethoxy)-2-methyl-1-propyllithium, 3-(1,1-dimethylethoxy)-2,2-dimethyl-1-propyllithium, 4-(1,1-dimethylethoxy)-1-butyllithium, 5-(1,1-dimethylethoxy)-1-pentyllithium, 6-(1,1-dimethylethoxy)-1-hexyllithium, 8-(1,1-dimethylethoxy)-1-octyllithium, 3-(1,1-dimethylpropoxy)-1-propyllithium, 3-(1,1-dimethylpropoxy)-2-methyl-1-propyllithium, 3-(1,1-dimethylpropoxy)-2,2-dimethyl-1-propyllithium, 4-(1,1-dimethylpropoxy)-1-butyllithium, 5-(1,1-dimethylpropoxy)-1-pentyllithium, 6-(1,1-dimethylpropoxy)-1-hexyllithium, 8-(1,1-dimethylpropoxy)-1-octyllithium, 4-(methoxy)-1-butyllithium, 4-(ethoxy)-1-butyllithium, 4-(n-propyloxy)-1-butyllithium, 4-(1-methylethoxy)-1-butyllithium, 3-[3-(dimethylamino)-1-propyloxy]-1-propyllithium, 3-[2-(dimethylamino) -1-ethoxy]-1-propyllithium, 3-[2-(diethylamino)-1-ethoxy]-1-propyllithium, 3-[2-(diisopropyl)amino)-1-ethoxy]-1-propyllithium, 3-[2-(1-piperidino)-1-ethoxy]-1-propyllithium, 3-[2-(1-pyrrolidino)-1-ethoxy]-1-propyllithium, 4-[3-(dimethylamino)-1-propyloxy]-1-butyllithium, 6-[2-(1-piperidino)-1-ethoxy]-1-hexyllithium, 3-[2-(methoxy)-1-ethoxy]-1-propyllithium, 3-[2-(ethoxy)-1-ethoxy]-1-propyllithium, 4-[2-(methoxy)-1-ethoxy]-1-butyllithium, 5-[2-(ethoxy)-1-ethoxy]-1-pentyllithium, 3-[3-(methylthio)-1-propyloxy]-1-propyllithium, 3-[4-(methylthio)-1-butyloxy]-1-propyllithium, 3-(methylthiomethoxy)-1-propyllithium, 6-[3-(methylthio)-1-propyloxy]-1-hexyllithium, 3-(N,N-dimethylamino)-1-propyllithium, 3-(N,N-dimethylamino)-2-methyl-1-propyllithium, 3-(N,N-dimethylamino)-2,2-dimethyl-1-propyllithium, 4-(N,N-dimethylamino) -1-butyllithium, 5-(N,N-dimethylamino)-1-pentyllithium, 6-(N,N-dimethylamino) -1-hexyllithium, 3-(N,N-diethylamino)-1-propyllithium, 3-(N,N-diethylamino) -2-methyl-1-propyllithium, 3-(N,N-diethylamino)-2,2-dimethyl-1-propyllithium, 4-(N,N-diethylamino)-1-butyllithium, 5-(N,N-diethylamino)-1-pentyllithium, 6-(N,N-diethylamino)-1-hexyllithium, 3-(N-ethyl-N-methylamino)-1-propyllithium, 3-(N-ethyl-N-methylamino)-2-methyl-1-propyl halide, 3-(N-ethyl-N-methylamino) -2,2-dimethyl-1-propyl halide, 4-(N-ethyl-N-methylamino)-1-butyllithium, 5-(N-ethyl-N-methylamino)-1-pentyllithium, 6-(N-ethyl-N-methylamino)-1-hexyllithium, 3-(piperidino)-1-propyllithium, 3-(piperidino)-2-methyl-1-propyllithium, 3-(piperidino) -2,2-dimethyl-1-propyllithium, 4-(piperidino)-1-butyllithium, 5-(piperidino)-1-pentyllithium, 6-(piperidino)-1-hexyllithium, 3-(pyrrolidino)-1-propyllithium, 3-(pyrrolidino)-2-methyl-1-propyllithium, 3-(pyrrolidino)-2,2-dimethyl-1-propyllithium, 4-(pyrrolidino)-1-butyllithium, 5-(pyrrolidino)-1-pentyllithium, 6-(pyrrolidino)-1-hexyllithium, 3-(hexamethyleneimino)-1-propyllithium, 3-(hexamethyleneimino)-2-methyl-1-propyllithium, 3-(hexamethyleneimino)-2,2-dimethyl-1-propyllithium, 4-(hexamethyleneimino)-1-butyllithium, 5-(hexamethyleneimino)-1-pentyllithium, 6-(hexamethyleneimino)-1-hexyllithium, 3-(2,2,5,5-tetramethyl-2,5-disila-1-azacyclopentane)-1-propyllithium, 4-(2,2,5,5-tetramethyl-2,5-disila-1-azacyclopentane) -1-butyllithium, 6-(2,2,5,5-tetramethyl-2,5-disila-1-azacyclopentane)-1-hexyllithium, 3-(N-isopropyl-N-methyl)-1-propyllithium, 2-(N-isopropyl-N-methyl)-2-methyl-1-propyllithium, 3-(N-isopropyl-N-methyl)-2,2-dimethyl-1-propyllithium, and 4-(N-isopropyl-N-methyl) -1-butyllithium, 3-(methylthio)-1-propyllithium, 3-(methylthio)-2-methyl-1-propyllithium, 3-(methylthio)-2,2-dimethyl-1-propyllithium, 4-(methylthio)-1-butyllithium, 5-(methylthio)-1-pentyllithium, 6-(methylthio)-1-hexyllithium, 8-(methylthio)-1-octyllithium, 3-(methoxymethylthio)-1-propyllithium, 3-(methoxymethylthio)-2-methyl-1-propyllithium, 3-(methoxymethylthio)-2,2-dimethyl-1-propyllithium, 4-(methoxymethylthio)-1-butyllithium, 5-(methoxymethylthio)-1-pentyllithium, 6-(methoxymethylthio)-1-hexyllithium, 8-(methoxymethylthio)-1-octyllithium, 3-(1,1-dimethylethylthio)-1-propyllithium, 3-(1,1-dimethylethylthio)-2-methyl-1-propyllithium, 3-(1,1-dimethylethylthio)-2,2-dimethyl-1-propyllithium, 4-(1,1-dimethylethylthio)-1-butyllithium, 5-(1,1-dimethylethylthio)-1-pentyllithium, 6-(1,1-dimethylethylthio)-1-hexyllithium, 8-(1,1-dimethylethylthio)-1-octyllithium, 3-(1,1-dimethylpropylthio)-1-propyllithium, 3-(1,1-dimethylpropylthio)-2-methyl-1-propyllithium, 3-(1,1-dimethylpropylthio)-2,2-dimethyl-1-propyllithium, 4-(1,1-dimethylpropylthio)-1-butyllithium, 5-(1,1-dimethylpropylthio)-1-pentyllithium, 6-(1,1-dimethylpropylthio)-1-hexyllithium, 8-(1,1-dimethylpropylthio)-1-octyllithium, 3-(cyclopentylthio)-1-propyllithium, 3-(cyclopentylthio)-2-methyl-1-propyllithium, 3-(cyclopentylthio)-2,2-dimethyl-1-propyllithium, 4-(cyclopentylthio)-1-butyllithium, 5-(cyclopentylthio)-1-pentyllithium, 6-(cyclopentylthio)-1-hexyllithium, 8-(cyclopentylthio)-1-octyllithium, 3-(cyclohexylthio)-1-propyllithium, 3-(cyclohexylthio) -2-methyl-1-propyllithium, 3-(cyclohexylthio)-2,2-dimethyl-1-propyllithium, 4-(cyclohexylthio)-1-butyllithium, 5-(cyclohexylthio)-1-pentyllithium, 6-(cyclohexylthio) -1-hexyllithium, 8-(cyclohexylthio)-1-octyllithium, 3-(t-butyldimethylsilylthio)-1-propyllithium, 3-(t-butyldimethylsilylthio)-2-methyl-1-propyllithium, 3-(t-butyldimethylsilylthio) -2,2-dimethyl-1-propyllithium, 3-(t-butyldimethylsilylthio)-2-methyl-1-propyllithium, 4-(t-butyldimethylsilylthio)-1-butyllithium, 6-(t-butyldimethylsilylthio) -1-hexyllithium and 3-(trimethylsilylthio)-2,2-dimethyl-1-propyllithium, and the like and mixtures thereof. The chain extended analogues of these functionalized alkyllithium compounds can also be employed.

In other advantageous embodiments of the invention, the protected functionalized alkyllithium initiator can be include a tertiary amine functionality having two protecting groups, which may be the same or different. When the protecting groups are different, the groups are selected so as to have differential stability under specified deprotection conditions. Accordingly one of the protecting groups can be selectively removed without removing the other protecting group.

Such initiators include compounds of the formula (III):

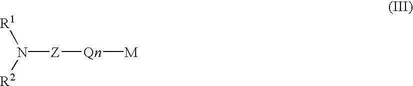

wherein:

M is an alkali metal selected from the group consisting of lithium, sodium and potassium;

Z is a branched or straight chain hydrocarbon connecting group which contains 3-25 carbon atoms, optionally substituted with aryl or substituted aryl;

Q is a saturated or unsaturated hydrocarbyl group, and can be derived by the incorporation of one or more unsaturated organic compounds, such as one or more compounds selected from the group consisting of conjugated diene hydrocarbons, alkenylsubstituted aromatic compounds, and mixtures thereof, into the M—Z linkage;

n is from 0 to 5;

R¹ is a protecting group selected from the group consisting of aralkyl, preferably benzyl or benzyl derivative, allyl, tertiary alkyl, preferably tertiary butyl, and methyl; and

R² can be the same as R¹, with the proviso that when R¹ is methyl, R² is not C₁-C₄ alkyl, or R² can be different from R¹, in which case R² is selected from the group consisting of alkyl, substituted alkyl, alkoxy, substituted alkoxy, aryl, substituted aryl, heteroaryl, substituted heteroaryl, cycloalkyl, substituted cycloalkyl, heterocycloalkyl, and substituted heterocycloalkyl, with the proviso that when R² is not the same as R¹, then R² is more stable under conditions used to remove R¹,

or R¹ and R² together with the nitrogen atom to which they are attached form

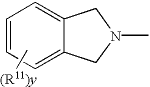

wherein y is from 1 to 4 and each R¹¹ is independently selected from the group consisting of hydrogen, alkyl, substituted alkyl, aryl, substituted aryl, cycloalkyl, substituted cycloalkyl, alkoxy, substituted alkoxy, heteroaryl, substituted heteroaryl, heterocycloalkyl, and substituted heterocycloalkyl.

The term “aralkyl” generally refers to aralkyl groups in which the total number of carbon atoms is no greater than about 18. The term aralkyl includes groups in which the alkylene chain and/or the aryl ring can include one or more heteroatoms, such as oxygen, nitrogen and sulfur. The alkylene chain and/or aryl ring can also be substituted with one or more groups such as C₁-C₄ alkyl, C₁-C₄ alkoxy, and the like, so long as the group does not interfere with the functionality of the benzyl protecting group and its removal, and/or with the activity of the lithium end of the compound.

Advantageous aralkyl groups in accordance with the invention are benzyl groups and benzyl derivatives. Benzyl derivatives include groups in which the phenyl ring is substituted with one or more groups such as C₁-C₄ alkyl, C₁-C₄ alkoxy, and the like, so long as the group does not interfere with the functionality of the benzyl protecting group and its removal, and/or with the activity of the lithium end of the compound. The term benzyl derivative also refers to benzyl groups in which the methylene linkage may also be substituted, for example, with one or more groups such as C₁-C₄ alkyl, C₁-C₄ alkoxy, aryl (phenyl) and the like, again so long as the group does not interfere with the functionality of the benzyl protecting group and its removal, and/or with the activity of the lithium end of the compound. Benzyl derivatives also include groups in which the ring and/or methylene chain can include heteroatoms, such as oxygen, sulfur or nitrogen. Such substituted benzyl protecting groups can be represented by the general formula:

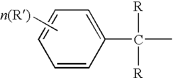

in which n is from 1 to 5; and each R and R′ is independently selected from the group consisting of hydrogen, alkyl, substituted alkyl, aryl, substituted aryl, cycloalkyl, substituted cycloalkyl, alkoxy, substituted alkoxy, heteroaryl, substituted heteroaryl, heterocycloalkyl, substituted heterocycloalkyl, and the like, or at least one R in combination with the phenyl ring forms a cyclic or bicyclic structure, such as

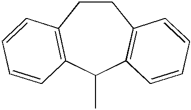

Exemplary R and R′ groups include without limitation methoxy, phenyl, methoxyphenyl, and the like. Exemplary substituted benzyl substituents include without limitation 4-methoxybenzyl, 2,4-dimethoxybenzyl, diphenylmethyl, 4-methoxyphenylmethyl, triphenylmethyl, (4-methoxylphenyl)diphenylmethyl, and the like.

In especially advantageous compounds of formula (III), the protecting group R¹ is aralkyl, preferably benzyl or a benzyl derivative; allyl; or tertiary alkyl, preferably tertiary butyl. In this aspect of the invention, advantageously R² is the same as R¹. Alternatively, in this aspect of the invention, R² is methyl. Examples of such compounds include without limitation 3-[(N-benzyl-N-methyl)amino]-1-propyllithium, 3-[(N,N-dibenzyl)amino]-1-propyllithium, 3-[(N-tert-butyl-N-methyl)amino]-1-propyllithium, 3-[(N,N-di-tert-butyl)amino]-1-propyllithium, and mixtures thereof.

In yet another embodiment of the invention, the protected functionalized alkyllithium initiator can include compounds represented generally by the following structure (IV):

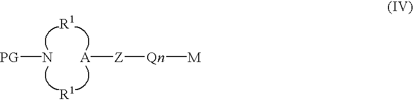

wherein:

M is an alkali metal selected from the group consisting of lithium, sodium and potassium;

Z is a branched or straight chain hydrocarbon connecting group which contains 3-25 carbon atoms, optionally substituted with aryl or substituted aryl;

Q is a saturated or unsaturated hydrocarbyl group, and can be derived by the incorporation of one or more unsaturated organic compounds, such as one or more compounds selected from the group consisting of conjugated diene hydrocarbons, alkenylsubstituted aromatic compounds, and mixtures thereof, into the M—Z linkage;

n is from 0 to 5;

A is N, P, CR or SiR, wherein R is selected from the group consisting of H and saturated or unsaturated aliphatic and aromatic radicals;

each R¹ is independently selected from the group consisting of alkylene and substituted alkylene; and

PG is a protecting group,

with the proviso that when A is —CR, then Z, Qn, or both, can be absent.

As used herein the term “alkylene” refers to C₁-C₁₀ alkylene. The term “substituted alkylene” refers to C₁-C₁₀ alkylene which is substituted with one or more heteroatoms (such as silyl-, amino- and oxy-substituted alkylene chains). Substituted alkylene also refers to C₁-C₁₀ alkylene having one or more substituents, such as but not limited to alkyl, substituted alkyl, cycloalkyl, substituted cycloalkyl, heterocycloalkyl, substituted heterocycloalkyl, alkoxy, substituted alkoxy, aryl, substituted aryl, heteroaryl, and substituted heteroaryl. The resultant ring is typically saturated, but the present invention includes unsaturated, non-aromatic ring structures as well.

As noted above, when A is P, CR or SiR, then the tether or connecting group “Z” and/or the chain extension Qn can be absent. However, when “A” is N, then at least the tether “Z” is present.

R can be any suitable monovalent organic radical, and in particular, hydrogen or a saturated or unsaturated aliphatic and aromatic radical. Exemplary saturated or unsaturated aliphatic and aromatic radicals include without limitation alkyl, substituted alkyl, aryl, substituted aryl, cycloalkyl, substituted cycloalkyl, alkoxy, substituted alkoxy, heteroaryl, substituted heteroaryl, heterocycloalkyl, substituted heterocycloalkyl, and the like. The referenced to “substituted” radicals includes substituents such as those described above with reference to the alkylene groups.

Particularly advantageous are compounds in which A is nitrogen and the resultant ring

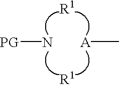

is a five or six membered heterocyclic radical, such as a piperazine ring.

The term “PG” refers to any types of organic substrates stable in the presence of an alkali metal but can be removed under selected conditions. Exemplary protecting groups include without limitation aralkyl, allyl, tertiary alkyl, such as tertiary butyl, methyl and silyl groups.

The compounds of formula (III) and (IV) are described in commonly owned copending U.S. application Ser. No. 09/665,528, filed Sep. 19, 2000, and Ser. No. 09/799,798, filed Mar. 6, 2001, the entire disclosure of each of which is hereby incorporated by reference.

As used herein, the term “alkyl” refers to straight chain and branched C₁-C₂₅ alkyl. The term “substituted alkyl” refers to C₁-C₂₅ alkyl substituted with one or more lower C₁-C₁₀ alkyl, lower alkoxy, lower alkylthio, or lower dialkylamino. The term “cycloalkyl” refers to one or more rings, typically of 5, 6 or 7 atoms, which rings may be fused or unfused, and generally including 3 to 12 carbon atoms. The term “substituted cycloalkyl” refers to cycloalkyl as defined above and substituted with one or more lower C₁-C₁₀ alkyl, lower alkoxy, lower alkylthio, or lower dialkylamino. The term “aryl” refers to C₅-C₂₅ aryl having one or more aromatic rings, generally each of 5 or 6 carbon atoms. Multiple aryl rings may be fused, as in naphthyl or unfused, as in biphenyl. The term “substituted aryl” refers to C₅-C₂₅ aryl substituted with one or more lower C₁-C₁₀ alkyl, lower alkoxy, lower alkylthio, or lower dialkylamino. Exemplary aryl and substituted aryl groups include, for example, phenyl, benzyl, and the like. The term “alkoxy” refers to straight chain and branched C₁-C₂₅ alkoxy. The term “substituted alkoxy” refers to C₁-C₂₅ alkoxy substituted with one or more lower C₁-C₁₀ alkyl, lower alkoxy, lower alkylthio, or lower dialkylamino. The terms “heteroaryl” and “substituted heteroaryl” refer to aryl and substituted aryl as defined above which can include one to four heteroatoms, like oxygen, sulfur, or nitrogen or a combination thereof, which heteroaryl group is optionally substituted at carbon and/or nitrogen atom(s) with the groups such as noted above. The terms “heterocycloalkyl” and “substituted heterocycloalkyl” refer to cycloalkyl and substituted cycloalkyl as defined above having one or more rings of 5, 6 or 7 atoms with or without saturation or aromatic character and at least one ring atom which is not carbon. Exemplary heteroatoms include sulfur, oxygen, and nitrogen. Multiple rings may be fused or unfused. The term silyl refers to an organosilicon compound, typically having from 3 to 25 carbon atoms. Advantageous silyl protecting groups include linear and branched alkyl substituents, such as exemplified by the silyl groups tertiary butyl, dimethyl silyl and trimethyl silyl.

The additives can be added as part of the initiator composition, added to the polymerization reactor prior to the polymerization, as part of the monomer charge, or at the end of polymerization. The organometallic compound is present in an amount sufficient to thermally stabilize the alkyllithium species without significantly compromising or inhibiting the reactivity of the alkyllithium species. The quantity of the additive required depends on several factors, such as but not limited to the identity of the alkyllithium initiator, the concentration of the initiator, the solvent, the identity of the additive(s), and the like. In general, the organometallic additives are employed in an amount less than about 10 mol %, based on the amount of lithiated species present (or less than about 0.1 molar equivalents). As little as about 0.1 mol % (or 0.001 mol equivalents) additive, based on the amount of lithiated species, may be employed. Even amounts of the additive as low as 0.001 mol % (or 0.00001 mol equivalents) can be effective to thermally stabilize the compositions of the invention. Advantageously the additive is present in an amount ranging from about 1 to about 7 mol % (about 0.01 to about 0.07 equivalents), based on the amount of lithiated species present.

The monomer to be polymerized is selected from the group consisting of conjugated diene hydrocarbons, such as butadiene and isoprene, and alkenylsubstituted aromatic compounds, such as styrene and alpha-methylstyrene. The monomers may be polymerized alone, or in admixture with one other to form random copolymers, or by charging monomer to the reaction mixture sequentially to form block copolymers. Examples of conjugated diene hydrocarbons include, but are not limited to, 1,3-butadiene, isoprene, 2,3-dimethyl-1,3-butadiene, 1,3-pentadiene, myrcene, 2-methyl-3-ethyl-1,3-butadiene, 2-methyl-3-ethyl-1,3-pentadiene, 1,3-hexadiene, 2-methyl-1,3-hexadiene, 1,3-heptadiene, 3-methyl-1,3-heptadiene, 1,3-octadiene, 3-butyl-1,3-octadiene, 3,4-dimethyl-1,3-hexadiene, 3-n-propyl-1,3-pentadiene, 4,5-diethyl-1,3-octadiene, 2,4-diethyl-1,3-butadiene, 2,3-di-n-propyl-1,3-butadiene, 2-methyl-3-isopropyl-1,3-butadiene, and the like and mixtures thereof.

Examples of polymerizable alkenylsubstituted aromatic compounds which can be anionically polymerized include, but are not limited to, styrene, alpha-methylstyrene, vinyltoluene, 2-vinylpyridine, 4-vinylpyridine, 1-vinylnaphthalene, 2-vinylnaphthalene, 1-alpha-methylvinylnaphthalene, 2-alpha-methylvinylnaphathalene, 1,2-diphenyl-4-methyl-1-hexene and mixtures of these, as well as alkyl, cycloalkyl, aryl, alkaryl and aralkyl derivatives thereof in which the total number of carbon atoms in the combined hydrocarbon constituents is generally not greater than 18. Examples of these latter compounds include without limitation 3-methylstyrene, 3,5-diethylstyrene, 2-ethyl-4-benzylstyrene, 4-phenylstyrene, 4-p-tolylstyrene, 2,4-divinyltoluene and 4,5-dimethyl-1-vinylnaphthalene. Reference is made to U.S. Pat. No. 3,377,404 for disclosures of additional alkenylsubstituted aromatic compounds.

The inert solvent employed during the polymerizations is preferably a non-polar solvent such as a hydrocarbon, since anionic polymerization in the presence of such non-polar solvents is known to produce polyenes with high 1,4-contents from 1,3-dienes. Inert hydrocarbon solvents useful in practicing this invention include but are not limited to inert liquid alkanes, cycloalkanes and aromatic solvents such as alkanes and cycloalkanes containing five to ten carbon atoms such as pentane, hexane, cyclohexane, methylcyclohexane, heptane, methylcycloheptane, octane, decane and so forth and aromatic solvents containing six to ten carbon atoms such as benzene, toluene, ethylbenzene, p-xylene, m-xylene, o-xylene, n-propylbenzene, isopropylbenzene, n-butylbenzene, and the like.

Polar solvents (modifiers) can be added to the polymerization reaction to alter the microstructure of the resulting polymer, i.e., increase the proportion of 1,2 (vinyl) microstructure or to promote functionalization or randomization. Examples of polar modifiers include, but are not limited to, diethyl ether, dibutyl ether, tetrahydrofuran, 2-methyltetrahydrofuran, methyl tert-butyl ether, 1,2-dimethoxyethane (glyme), 1,2-diethoxyethane, diazabicyclo[2.2.2]octane, triethylamine, tributylamine, N-methylpiperidine, N-methylpyrrolidine, and N,N,N′,N′-tetramethylethylene diamine (TMEDA). The amount of the polar modifier added depends on the vinyl content desired, the nature of the monomer, the temperature of the polymerization, and the identity of the polar modifier. The polar solvent (modifier) can be added to the reaction medium at the beginning of the polymerization as part of the solvent reaction medium or added during the polymerization.

The intermediate living polymer can be reacted with a suitable protonating, functionalizing, or coupling or linking agent, as known in the art. In one aspect of the invention, the living polymer is reacted with a functionalizing agent (or electrophile) of the formula

X—Y—T—(A′—R¹²R¹³R¹⁴)ₙ

wherein:

X is halide selected from the group consisting of chloride, bromide and iodide;

Y is a branched or straight chain hydrocarbon connecting group which contains 1-25 carbon atoms, optionally substituted with aryl or substituted aryl;

T is selected from the group consisting of oxygen, sulfur, and nitrogen and mixtures thereof;

A′ is an element selected from Group IVa of the Periodic Table of the Elements;

R¹², R¹³, and R¹⁴ are each independently selected from the group consisting of hydrogen, alkyl, substituted alkyl, aryl, substituted aryl, cycloalkyl, and substituted cycloalkyl, or R¹⁴ is optionally a —(CR¹⁵R¹⁶)ₗ— group linking two A′ when n is 2, wherein R¹⁵ and R¹⁶ are each independently selected from the group consisting of hydrogen, alkyl, substituted alkyl, aryl, substituted aryl, cycloalkyl, and substituted cycloalkyl, and l is an integer from 1 to 7; and

n is 1 when T is oxygen or sulfur, and 2 when T is nitrogen. Thus the skilled artisan will appreciate that R¹⁴ as used herein includes the group

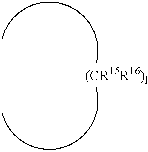

linking two A′ groups when n is 2.

The functionalizing agents can be prepared as described, for example, in International Publication WO 97/16465, the entire disclosure of which is incorporated by reference. In addition, the electrophiles can be prepared as described in K. Ueda, A. Hirao, and S. Nakahama, Macromolecules, 23, 939 (1990); U.S. Pat. No. 5,496,940; U.S. Pat. No. 5,600,021; U.S. Pat. No. 5,362,699; A. Alexakis, M. Gardette, and S. Colin, Tetrahedron Letters, 29, 1988, 2951; B. Figadere, X. Franck, and A. Cave, Tetrahedron Letters, 34, 1993, 5893; J. Almena, F. Foubelo, and M. Yus, Tetrahedron, 51, 1995, 11883; D. F. Taber and Y. Wang, J. Org. Chem., 58, 1993, 6470; F. D. Toste and I. W. J. Still, Synlett, 1995, 159; and U.S. Pat. No. 5,493,044. The functionalization step can be conducted at temperatures ranging from about −30° C. to about 150° C.

Other compounds useful in functionalizing living polymers include, but are not limited to, alkylene oxides, such as ethylene oxide, propylene oxide, styrene oxide, and oxetane; oxygen; sulfur; carbon dioxide; halogens such as chlorine, bromine and iodine; propargyl halides; alkenylhalosilanes and omega-alkenylarylhalosilanes, such as styrenyldimethyl chlorosilane; sulfonated compounds, such as 1,3-propane sultone; amides, including cyclic amides, such as caprolactam, N-benzylidene trimethylsilylamide, and dimethyl formamide; silicon acetals; 1,5-diazabicyclo[3.1.0]hexane; allyl halides, such as allyl bromide and allyl chloride; methacryloyl chloride; amines, including primary, secondary, tertiary and cyclic amines, such as 3-(dimethylamino)-propyl chloride and N-(benzylidene)trimethylsilylamine; epihalohydrins, such as epichlorohydrin, epibromohydrin, and epiiodohydrin; haloalkyl trialkoxysilanes; and other materials as known in the art to be useful for terminating or end capping polymers. These and other useful functionalizing agents are described, for example, in U.S. Pat. Nos. 3,786,116 and 4,409,357, the entire disclosure of each of which is incorporated herein by reference.

Examples of difunctional coupling include, but are not limited to, Me₂SiCl₂, Me₂Si(OMe)₂, Me₂SnCl₂, Ph₂SiCl₂, MePhSiCl₂, ClMe₂SiCH₂CH₂SiMe₂Cl, and Me₂SiBr₂, BrMe₂Br, and the like and mixtures thereof.

Examples of useful multifunctional linking or coupling agents include isomeric (mixtures of ortho, meta and para) dialkenylaryls and isomeric di- and trivinylaryls, such as 1,2-divinylbenzene, 1,′-)-divinylbenzene, 1,4-divinylbenzene, 1,2,4-trivinylbenzenes, 1,3-divinylnaphthalenes, 1,8-divinylnaphthalene, 1,2-diisopropenylbenzene, 1,3-diisopropenylbenzene, 1,4-diisopropenylbenzene, 1,-′1,5-trivinylnaphthalene, and other suitable materials known in the art to be useful for coupling polymers, as well as mixtures of coupling agents. See also U.S. Pat. Nos. 3,639,517 and 5,489,649, and R. P. Zelinski et al in J.Polym.Sci., A3, 93, (1965) for these and additional coupling agents. Mixtures of coupling agents can also be used. Generally, the amount of coupling agent used is such that the molar ratio of protected living polymer anions to coupling agents ranges from 1:1 to 24:1. This linking process is described, for example, in U.S. Pat. No. 4,409,357 and by L. J. Fetters in Macromolecules, 9,732 (1976).

The resultant polymer thus can be a linear, homotelechelic, heterotelechelic, branched, or radial polymer having one or more terminal tertiary amino functional groups. The polymer can be recovered from the reaction media and optionally hydrogenated and/or deprotected.

If a mixture of monomers is employed in the polymerization, the monomers can be added together to afford random or tapered block copolymers. The monomers can also be charged to the reactor sequentially to afford block copolymers.

The polymers produced may be optionally hydrogenated to afford additional novel, functionalized polymers. Examples of methods to hydrogenate the polymers of this invention are described in Falk, Journal of Polymer Science: Part A-1, vol. 9, 2617-2623 (1971), Falk, Die Angewandte Chemie, 21, 17-23 (1972), U.S. Pat. Nos. 4,970,254, 5,166,277, 5,393,843, 5,496,898, and 5,717,035. The hydrogenation of the functionalized polymer is conducted in situ, or in a suitable solvent, such as hexane, cyclohexane or heptane. This solution is contacted with hydrogen gas in the presence of a catalyst, such as a nickel catalyst. The hydrogenation is typically performed at temperatures from 25° C. to 150° C., with a archetypal hydrogen pressure of 15 psig to 1000 psig. The progress of this hydrogenation can be monitored by InfraRed (IR) spectroscopy or Nuclear Magnetic Resonance (NMR) spectroscopy. The hydrogenation reaction is conducted until at least 90% of the aliphatic unsaturation has been saturated. The hydrogenated functional polymer is then recovered by conventional procedures, such as removal of the catalyst with aqueous acid wash, followed by solvent removal or precipitation of the polymer.

If desired, the protecting groups can be removed from the protected polymers. For example, to remove tert-alkyl-protected groups, the protected polymer is mixed with Amberlyst 15 ion exchange resin and heated at an elevated temperature, for example 150° C., until deprotection is complete. In addition, tert-alkyl-protected groups can also be removed by reaction of the silicone polymer with trifluoroacetic acid, or trimethylsilyliodide. Additional methods of deprotection of the tert-alkyl protecting groups can be found in T. W. Greene and P. G. M. Wuts, Protective Groups in Organic Synthesis, Second Edition, Wiley, New York, 1991, page 41. The tert-butyldimethylsilyl protecting groups can be removed by treatment of the polymer with acid, such as hydrochloric acid, acetic acid, paratoluenesulfonic acid, or Dowex® 50W-X8. Additional methods of deprotection of the tert-butyldimethylsilyl protecting groups can be found in T. W. Greene and P. G. M. Wuts, Protective Groups in Organic Synthesis, Second Edition, Wiley, New York, 1991, pages 80-83.

The following table details experimental conditions that will selectively remove one of the protecting groups (more labile) from the polymer, while retaining the other protecting group (more stable).

| LABILE | STABLE | CONDITIONS |
|---|---|---|
| t-Butyldimethylsilyl | t-Butyl | Tetrabutylammonium fluoride |
| t-Butyldimethylsilyl | t-Butyl | 1 N HCl |
| t-Butyldimethylsilyl | Dialkylamino | Tetrabutylammonium fluoride |
| t-Butyldimethylsilyl | Dialkylamino | 1 N HCl |
| t-Butyl | Dialkylamino | Amberlyst ® resin |
| t-Amyl | Dialkylamino | Amberlyst ® resin |
| Trimethylsilyl | t-Butyl | Tetrabutylammonium fluoride |
| Trimethylsilyl | t-Butyl | 1 N HCl |
| Trimethylsilyl | Dialkylamino | Tetrabutylammonium fluoride |
| Trimethylsilyl | Dialkylamino | 1 N HCl |
| 2,2,5,5-Tetramethyl-2,5- | t-Butyl | Tetrabutylammonium Fluoride |
| disila-1-azacyclopentane | | |
| 2,2,5,5-Tetramethyl-2,5- | t-Butyl | 1 N HCl |
| disila-1-azacyclopentane | | |
| 2,2,5,5-Tetramethyl-2,5- | Dialkylamino | Tetrabutylammonium Fluoride |
| disila-1-azacyclopentane | | |
| 2,2,5,5-Tetramethyl-2,5- | Dialkylamino | 1 N HCl |
| disila-1-azacyclopentane | | |

The present invention also provides thermally stable living polymer compositions. The living polymer compositions of the invention generally include a polymer component (living polymer anions) in combination with one or more of the additives described above. The additives are generally present in the amounts noted above.

The present invention also provides polymer compositions in which the stabilized living polymer chains are subsequently functionalized or coupled as described above. In this regard, the polymers exhibit efficient formation of block polymers, end group functionalizations and/or coupling to form linear or radial (star) polymers. For example, living polymer anions can be coupled to form triblocks, functionalized using electrophiles to provide functionalized polymers, and/or coupled to make star polymers with at least about 90% efficiency, or higher.

As noted above, the additive(s) can be provide via an initiator composition. Such initiator compositions can also have the benefit of improved “thermal stability” as compared to the same initiator composition without an additive. The term “thermally stable composition” refers to compositions having higher carbon bound lithium values (or increased active carbon-lithium species) as compared to formulations without an additive. Preferably the compositions useful in the invention have carbon bound lithium values of at least about 90% and higher, determined using titration, after the compositions are stored for 5 days at 40° C. Alternatively “thermal stability” refers to compositions having decreased lithium hydride precipitation. For example, secondary butyllithium compositions with additive can measure less than about 100 ntu (nephelometer tubidity units) determined using a nephelometer after being stored for 24 hours at 40° C., in contrast to an identical secondary butyllithium formulation without additive (which exhibits about 1668 ntu after being stored at 40° C. for 24 hours).

It is believed that these additives interact with lithiated species, such as alkyllithium compounds and lithiated living polymer anions, as can be determined by proton and/or carbon nuclear magnetic resonance (NMR). Although not wishing to be bound by any explanation of the invention, it is currently believed that these interactions stabilize the lithiated species to prevent or minimize thermal degradation. However, the interactions are reversible, and thus still allow the lithiated species to perform the desired chemistry. For example, the stabilized initiators can initiate an anionic polymerization and the stabilized lithiated living polymers can participate in protonation, functionalization and other reactions. Thus, the additives can be generally be described as compounds which are capable of reversibly interacting with the lithiated species, advantageously in a hydrocarbon solvent system, to stabilize the lithiated species and to allow the lithiated species to perform the desired chemistry in downstream applications.

The compositions useful in the invention may be prepared in several ways. The preferred technique depends on various factors such as but not limited to the identity of the functionalized alkyllithium species and the identity of the additive(s). Generally one or more organometallic compounds and/or precursor(s) thereof can be added to the composition prior to, during or after the synthesis of the functionalized alkyllithium species. For example, an organometallic additive and/or its precursor may be added during the synthesis of the functionalized alkyllithium species. In this mode, the organometallic compound and/or its precursor can be added to solvent prior to or substantially simultaneously with the addition of an alkyllithium precursor halide. The organometallic compound and/or its precursor may also be mixed with the alkyllithium precursor halide, and thus added substantially simultaneously to the reactor with the alkyllithium precursor halide. The organometallic compound and/or its precursor can alternatively be added to the reaction mixture after addition of an alkyllithium precursor halide. Still further, the organometallic compound and/or its precursor can be introduced into a lithium dispersion and thus added to a reaction mixture substantially simultaneously with the addition of the lithium dispersion. In another mode, the organometallic compound and/or its precursor may be added to the formulation after the synthesis of the alkyllithium is substantially complete, either prior to or after filtration to remove the by-product lithium halide.

As a non-limiting example, in one embodiment, an organometallic compound precursor, such as a metal precursor like magnesium metal, can be added to solvent in a reactor prior to or substantially simultaneously with the addition of the alkyllithium precursor halide. As another non-limiting example, an active metal halide or alkoxide can be added to the alkyllithium composition, again prior to, during or after the synthesis reaction. Typically the active metal halide or alkoxide precursor is added to the composition after the synthesis reaction, either prior to or after filtration. The active metal halide or alkoxide can be represented generally by the formula MeXₙ, wherein Me is the metal, X is halide or C₁-C₁₀ alkoxide, and n is the valence of the metal.

The present invention will be further illustrated by the following non-limiting examples.

### INITIATOR PREPARATION

### Example 1

### Preparation of 3-Trimethylsilyloxy-1-propyllithium with Dibutylmagnesium

A 500 mL, three-necked Morton flask was equipped with a mechanical stirrer, a Claisen adapter fitted with a dry ice condenser and gas inlet, and a 100 milliliter pressure-equalizing dropping funnel. This apparatus was dried in an oven overnight at 125° C., assembled hot, and allowed to cool to room temperature. Lithium metal dispersion was washed free of mineral oil with hexane (2×100 ml), and pentane (1×100 ml). The resultant lithium dispersion was dried in a stream of argon, weighed, 6.05 grams (0.87 moles) and transferred to the reaction flask with cyclohexane (181 g). To the lithium suspension was added 15 wt % dibutylmagnesium (14 g, 0.015 mol) in heptane. The mechanical stirrer was set at an agitation rate of 500 RPMs, and the reaction mixture was heated to 65° C. with a heating mantle. The heat source was removed. The dropping funnel was charged with 3-trimethylsilyloxy-1-propylchloride (52.2 g, 0.31 mol). The precursor was added dropwise, at an approximate feed rate of 1.63 ml/min. The reaction mixture was maintained at 60° C. with a dry ice/hexane bath. The reaction was allowed to stir for an additional one hour and maintained at a temperature of 60° C. with a heating mantle. The reaction mixture was then allowed to cool to room temperature and transferred to a medium porosity pressure filter. The lithium muds were washed with cyclohexane (1×43 gms) to afford 260.1 gms (75.5% yield based on % active) of the title compound in cyclohexane.

### Comparative Example

### Preparation of 3-Trimethylsilyloxy-1-propyllithium without Dibutylmagnesium

A 500 mL, three-necked Morton flask was equipped with a mechanical stirrer, a Claisen adapter fitted with a dry ice condenser and gas inlet, and a 100 milliliter pressure-equalizing dropping funnel. This apparatus was dried in an oven overnight at 125° C., assembled hot, and allowed to cool to room temperature in a stream of argon. Lithium metal dispersion was washed free of mineral oil with hexane (2×100 ml), and pentane (1×100 ml). The resultant lithium dispersion was dried in a stream of argon, weighed, 9.9 grams (1.43 moles) and transferred to the reaction flask with cyclohexane (310 g). The mechanical stirrer was set at an agitation rate of 500 RPMs, and the reaction mixture was heated to 65° C. with a heating mantle. The heat source was removed. The dropping funnel was charged with 3-trimethylsilyloxy-1-propylchloride (85.01 g, 0.51 mol). The precursor was added dropwise, at an approximate feed rate of 1.63 ml/min. The reaction mixture was maintained at 60° C. with a dry ice/hexane bath. The reaction was allowed to stir for an additional one hour and maintained at a temperature of 60° C. with a heating mantle. The reaction mixture was then allowed to cool to room temperature and transferred to a medium porosity pressure filter. The lithium muds were washed with cyclohexane (1×50 gms) to afford 381.7 gms (52.6% yield based on % active) of the title compound in cyclohexane.

The stability of 3-trimethylsilyloxy-1-propyllithum (TMSO—(CH₂)₃—Li) in the presence of dibutylmagnesium (DBM) as prepared in Example 1 was evaluated and compared with the stability of TMSO—(CH₂)₃—Li without DBM as prepared in the above comparative example. The results are set forth in the table below. Thermal stability was evaluated by analyzing samples of the solutions for total base and for active, carbon-bound lithium, by the method of S. C. Watson and J. F. Eastham, J. Organomet. Chem., 9, 165 (1967). The data demonstrates that the presence of the additive improves stability as exemplified by increased yield and an increase in the carbon bound lithium value.

| | | | | CARBON | |
|---|---|---|---|---|---|
| | | | ACTIVE WT | BOUND | |
| Alkyllithium | ADDITIVE | LOADING | % | LITHIUM | YIELD |
| TMSO-(CH₂)₃-Li | None | 0 | 9.7 | 62.2 | 52.6 |
| TMSO-(CH₂)₃-Li | Dibutylmagnesuim | 5 mol % | 12.57 | 81.3 | 75.5 |

### Example 2

### Preparation of 2,2-Dimethyl-3-trimethylsilyloxy-1-propyllithium and Stability

### Comparison of Same with and without Dibutylmagnesium

A 1 L Morton flask was equipped with a mechanical stirrer, a Claisen adapter fitted with a dry ice condenser and gas inlet, and a 100 milliliter pressure-equalizing dropping funnel. This apparatus was dried in an oven overnight at 125° C., assembled hot, and allowed to cool to room temperature in a stream of argon. Lithium metal dispersion was washed free of mineral oil with hexane (2×100 ml), and pentane (1×100 ml). The resultant lithium dispersion was dried in a stream of argon, weighed, 8.47 grams (1.2 moles) and transferred to the reaction flask with cyclohexane (320 g). The mechanical stirrer was set at an agitation rate of 500 RPMs, and the reaction mixture was heated to 70° C. with a heating mantle. The heat source was removed. The dropping funnel was charged with 2,2-dimethyl-3-trimethylsilyloxy-1-propylchloride (84.82 g, 0.44 mol). The precursor was added dropwise, at an approximate feed rate of 1.63 ml/min. The reaction mixture was maintained at 65° C. with a dry ice/hexane bath. The reaction was allowed to stir for an additional one hour and maintained at a temperature of 65° C. with a heating mantle. The reaction mixture was then allowed to cool to room temperature and transferred to a medium porosity pressure filter. The lithium muds were washed with cyclohexane (1×49 gms) to afford 452 gms (90.0% yield based on % active) of the title compound in cyclohexane.

The stability of 2,2-dimethyl-3-trimethylsilyloxy-1-propyllithium was performed in a separate experiment. The prepared 2,2-dimethyl-3-trimethylsilyloxy-1-propyllithium was separated into three different lots. Lot 1 contained 14.4 wt % 2,2-dimethyl-3-trimethylsilyloxy-1-propyllithium (87.09 g). Lot 2 contained 14.4 wt % 2,2-dimethyl-3-trimethylsilyloxy-1-propyllithium (87.09 g) and was treated with 14.0 wt % dibutylmagnesium (0.77 g). Lot 3 contained 14.4 wt % 2,2-dimethyl-3-trimethylsilyloxy-1-propyllithium (88.25 g) and was treated with 14.0 wt % dibutylmagnesium (3.74 g). The table below shows the difference in activity after the samples were aged 13 and 36 days at 15° C.

| | | Lot 2 | Lot 3 |
|---|---|---|---|
| | | (1.2 mol % | (5.8 mol % |
| | Lot 1 (control) | DBM) | DBM) |
| 13 days @ 15° C. | | | |
| Total base (mol/kg) | 0.92 | 0.91 | 0.96 |
| Active (mol/kg) | 0.86 | 0.90 | 0.92 |
| 36 days @ 15° C. | | | |
| Total base (mol/kg) | 0.87 | 0.91 | 0.95 |
| Active (mol/kg) | 0.43 | 0.88 | 0.90 |

The following table demonstrates a two fold increase in storage stability for TMSOCH₂C(CH₃)₂CH₂Li when treated with dibutylmagnesium after the 3-(trimethylsilyloxy)-2,2-dimethyl-1-propyllithium was prepared and isolated.

| | | | | | CARBON |
|---|---|---|---|---|---|
| | | | Days @ | ACTIVE WT | BOUND |
| Alkyllithium | ADDITIVE | LOADING | 15° C. | % | LITHIUM |
| TMSOCH₂C(CH₃)₂CH₂-Li | None | 0 | 36 days | 7.1 | 49% |
| TMSOCH₂C(CH₃)₂CH₂-Li | Dibutylmagnesium | 1 mol % | 36 days | 14.5 | 97% |
| TMSOCH₂C(CH₃)₂CH₂-Li | Dibutylmagnesium | 5 mol % | 36 days | 14.9 | 95% |

### LIVING POLYMER STABILITY TESTING

### Example 3

### Comparative Study of Butadiene Polymerization Using 2,2-dimethyl-3-trimethylsilyloxy-1-propyllithium with and without Dibutylmagnesium after 25 Days Aging at 25° C.

Initiator Preparation: A sample of 2,2-dimethyl-3-trimethylsilyloxy-1-propyllithium was prepared as described in Example 6. The initiator was separated under argon to give Lot A as the control, which contained 90 gms of 2,2-dimethyl-3-trimethylsilyloxy-1-propyllithium as a 20 wt % solution in cyclohexane; and Lot B, which contained 112 gms of 2,2-dimethyl-3-trimethylsilyloxy-1-propyllithium as a 20 wt % solution in cyclohexane. Lot B was treated with dibutylmagnesium (0.93 g, 6.7 mmol) or 5 mol % of dibutylmagnesium relative to 2,2-dimethyl-3-trimethylsilyloxy-1-propyllithium. Both Lot A and Lot B were stored at room temperature for 25 days and then utilized as initiators as described below.

Polymerization Using Lot A (control)

A 250 ml glass reactor is equipped with a one break-seal reagent ampoule, a sampling port attached with a Teflon stopcock, an inlet tube inlet fitted with a septum cap, and a magnetic stir bar. This reactor is flame sealed to a high vacuum line and evacuated at 120C for 8 hours. The flask is refilled with dry argon and allowed to cool to room temperature. To the reactor is added 3 mL of 2,2-dimethyl-3-trimethylsilyloxy-1-propyllithium/dibutylmagnesium (from Lot A) in cyclohexane. Cyclohexane (100 mL) and diethylether (15 mL) is then vacuum distilled directly into the reactor. The purified monomer 1,3-butadiene (10 g, 185 mmol) was then added from the break-seal ampoule. The reaction mixture was then placed in constant temperature bath at 30° C. until all of the 1,3-butadiene is consumed, about 15 hours. A 2 mL aliquot of the living polymer was withdrawn with a dry syringe through the sample port, quenched with degassed methanol, and analyzed by SEC. The resultant functionalized polymer is characterized by SEC and has the following properties.

Calculated Mₙ=4.6×10³ g/mol

Mₙ=7.1×10³ g/mole

M_{w}=7.3×10³ g/mole

M_{w}/Mₙ=1.1

Initiator efficiency=64%

Polymerization Using Lot B (Stabilized with dibutylmagnesium)

A 250 ml glass reactor is equipped with a one break-seal reagent ampoule, a sampling port attached with a Teflon stopcock, an inlet tube inlet fitted with a septum cap, and a magnetic stir bar. This reactor is flame sealed to a high vacuum line and evacuated at 120C for 8 hours. The flask is refilled with dry argon and allowed to cool to room temperature. To the reactor is added 3 mL of 2,2-dimethyl-3-trimethylsilyloxy-1-propyllithium/dibutylmagnesium (from Lot B) in cyclohexane. Cyclohexane (100 mL) and diethylether (15 mL) is then vacuum distilled directly into the reactor. The purified monomer 1,3-butadiene (10 g, 185 mmol) was then added from the break-seal ampoule. The reaction mixture was then placed in constant temperature bath at 30° C. until all of the 1,3-butadiene is consumed, about 15 hours. A 2 mL aliquot of the living polymer was withdrawn with a dry syringe through the sample port, quenched with degassed methanol, and analyzed by SEC. The resultant functionalized polymer is characterized by SEC and has the following properties.

Calculated Mₙ=4.8×10³ g/mol

Mₙ=6.0×10³ g/mole

M_{w}=6.3×10³ g/mole

M_{w}/Mₙ=1.1

Initiator efficiency=80%

The foregoing examples are illustrative of the present invention and are not to be construed as limiting thereof. Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A process for improved functionalization of living polymer anions, comprising anionically polymerizing one or more monomers in the presence of one or more functionalized alkyllithium initiators to form one or more living polymer anions, in the presence at least one organometallic compound capable of forming an ate complex with a lithiated species in an amount less than about 10 mol %, based on the amount of lithiated species present, so as to impart thermal stability to said living polymer anions without significantly inhibiting the reactivity of the lithiated species.

2. The process of claim 1, wherein said organometallic compound is soluble in hydrocarbon solvents.

3. The process of claim 1, wherein said organometallic compound is a compound of the formula MetR′ₙ, wherein:
Met is a metal selected from Group IIA, Group IIB, and Group III of the Periodic Table of Elements;
each R′ is independently selected from C₁-C₂₀ aliphatic hydrocarbons, C₂-C₂₀ cycloaliphatic hydrocarbons, C₅-C₂₀ aromatic hydrocarbons, and mixtures thereof; and
n is the valence of Met.

4. The process of claim 3, wherein said organometallic compound is a compound of the formula M¹R²⁰R²¹, wherein:
M¹ is an element of Group IIA or Group IIB; and
each R²⁰ and R²¹ is selected from the group consisting of C₁-C₂₀ aliphatic hydrocarbons, C₂-C₂₀ cycloaliphatic hydrocarbons, C₅-C₂₀ aromatic hydrocarbons, and mixtures thereof.

5. The process of claim 4, wherein M¹ is selected from the group consisting of beryllium, magnesium, calcium, strontium, barium, radium, zinc, cadmium, and mercury.

6. The process of claim 5, wherein M¹ is magnesium.

7. The process of claim 5, wherein M¹ is zinc.

8. The process of claim 3, wherein said organometallic compound is a compound of the formula M²R²³R²⁴R²⁵, wherein:
M² is an element of Group III; and
each R²³, R²⁴, and R²⁵ is selected from the group consisting of C₁-C₂₀ aliphatic hydrocarbons, C₂-C₂₀ cycloaliphatic hydrocarbons, C₅-C₂₀ aromatic hydrocarbons, and mixtures thereof.

9. The process of claim 8, wherein M² is selected from the group consisting of boron, aluminum, gallium, indium, and thallium.

10. The process of claim 9, wherein M² is aluminum.

11. The process of claim 1, wherein said organometallic compound is selected from the group consisting of diethylmagnesium, diisopropylmagnesium, dibutylmagnesium, dicyclohexylmagnesium, diphenylmagnesium, diethylzinc, dibutylzinc, diphenyl zinc, triethylaluminum, tripropylaluminum, triisopropylaluminum, tributylaluminum, trioctylaluminum, trimethylboron, triethylboron, and tributylboron and mixtures thereof

12. The process of claim 1, wherein said functionalized alkyllithium initiator comprises a compound of the formula
Li—Qₙ—Z—T—(A—R₁₀R₁₁R₁₂)ₘ
and 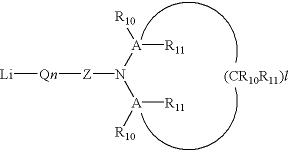
wherein:
Q is an unsaturated hydrocarbyl group derived by incorporation of one or more conjugated diene hydrocarbons, one or more alkenylaromatic compounds, or mixtures of one or more dienes with one or more alkenylaromatic compounds into the M—Z linkage;
n is from 0 to 5;
Z is a branched or straight chain hydrocarbon connecting group which contains 3-25 carbon atoms, optionally substituted with C₅-C₂₅ aryl or substituted C₅-C₂₅ aryl;
T is selected from the group consisting of oxygen, sulfur, and nitrogen groups and mixtures thereof;
(A—R₁₀R₁₁R₁₂)ₘ is a protecting group in which A is an element selected from Group IVa of the Periodic Table of the Elements, and R₁₀, R₁₁, and R₁₂ are each independently selected from the group consisting of hydrogen, C₁-C₁₅ alkyl, substituted C₁-C₁₅ alkyl, C₅-C₂₅ aryl, substituted C₅-C₂₅ aryl, C₅-C₁₂ cycloalkyl and substituted C₅-C₁₂ cycloalkyl;
l is an integer from 1 to 7; and
m is 1 when T is oxygen or sulfur, and 2 when T is nitrogen.

13. The process of claim 12, wherein A is carbon.

14. The process of claim 13, wherein T is nitrogen.

15. The process of claim 13, wherein T is oxygen.

16. The process of claim 13, wherein said organometallic compound is dibutylmagnesium.

17. The process of claim 12, wherein A is silicon.

18. The process of claim 12, wherein said functionalized initiator is 3-trimethylsilyloxy-1-propyllithium.

19. The process of claim 12, wherein said functionalized initiator is 2,2-dimethyl-3-trimethylsilyloxy-1-propyllithium.

20. The process of claim 12, wherein said functionalized alkyllithium initiator is selected from the group consisting of 3-(t-butyldimethylsilyloxy)-1-propyllithium, 3-(t-butyldimethyl-silyloxy) -2-methyl-1-propyllithium, 3-(t-butyldimethylsilyloxy)-2,2-dimethyl-1-propyllithium, 4-(t-butyldimethylsilyloxy)-1-butyllithium, 5-(t-butyldimethyl-silyloxy) -1-pentyllithium, 6-(t-butyldimethylsilyloxy)-1-hexyllithium, 8-(t-butyldimethylsilyloxy) -1-octyllithium, 3-(t-butyldiphenylsilyloxy)-1-propyllithium, 3-(t-butyldiphenylylsiloxy) -2-methyl-1-propyllithium, 3-(t-butyldiphenylsilyloxy)-2,2-dimethyl-1-propyllithium, 6-(t-butyldiphenylsilyloxy)-1-hexyllithium, 3-(triisopropylsilyloxy)-1-propyllithium, 3-(trimethylsilyloxy)-2,2-dimethyl-1-propyllithium, 3-(triethylsilyloxy)-2,2-dimethyl-1-propyllithium, 3-(1,1-dimethylethoxy) -1-propyllithium, 3-(1,1-dimethylethoxy)-2-methyl-1-propyllithium, 3-(1,1-dimethylethoxy)-2,2-dimethyl-1-propyllithium, 4-(1,1-dimethylethoxy)-1-butyllithium, 5-(1,1-dimethylethoxy)-1-pentyllithium, 6-(1,1-dimethylethoxy)-1-hexyllithium, 8-(1,1-dimethylethoxy)-1-octyllithium, 3-(1,1-dimethylpropoxy)-1-propyllithium, 3-(1,1-dimethylpropoxy)-2-methyl-1-propyllithium, 3-(1,1-dimethylpropoxy)-2,2-dimethyl-1-propyllithium, 4-(1,1-dimethylpropoxy)-1-butyllithium, 5-(1,1-dimethylpropoxy)-1-pentyllithium, 6-(1,1-dimethylpropoxy)-1-hexyllithium, 8-(1,1-dimethylpropoxy)-1-octyllithium, 4-(methoxy)-1-butyllithium, 4-(ethoxy)-1-butyllithium, 4-(n-propyloxy)-1-butyllithium, 4-(1-methylethoxy)-1-butyllithium, 3-[3-(dimethylamino)-1-propyloxy]-1-propyllithium, 3-[2-(dimethylamino)-1-ethoxy]-1-propyllithium, 3-[2-(diethylamino)-1-ethoxy]-1-propyllithium, 3-[2-(diisopropyl)amino)-1-ethoxy]-1-propyllithium, 3-[2-(1-piperidino)-1-ethoxy]-1-propyllithium, 3-[2-(1-pyrrolidino)-1-ethoxy]-1-propyllithium, 4-[3-(dimethylamino)-1-propyloxy]-1-butyllithium, 6-[2-(1-piperidino)-1-ethoxy]-1-hexyllithium, 3-[2-(methoxy)-1-ethoxy]-1-propyllithium, 3-[2-(ethoxy)-1-ethoxy]-1-propyllithium, 4-[2-(methoxy)-1-ethoxy]-1-butyllithium, 5-[2-(ethoxy)-1-ethoxy]-1-pentyllithium, 3-[3-(methylthio)-1-propyloxy]-1-propyllithium, 3-[4-(methylthio)-1-butyloxy]-1-propyllithium, 3-(methylthiomethoxy)-1-propyllithium, 6-[3-(methylthio)-1-propyloxy]-1-hexyllithium, 3-(N,N-dimethylamino)-1-propyllithium, 3-(N,N-dimethylamino) -2-methyl-1-propyllithium, 3-(N,N-dimethylamino)-2,2-dimethyl-1-propyllithium, 4-(N,N-dimethylamino)-1-butyllithium, 5-(N,N-dimethylamino)-1-pentyllithium, 6-(N,N-dimethylamino)-1-hexyllithium, 3-(N,N-diethylamino)-1-propyllithium, 3-(N,N-diethylamino)-2-methyl-1-propyllithium, 3-(N,N-diethylamino) -2,2-dimethyl-1-propyllithium, 4-(N,N-diethylamino)-1-butyllithium, 5-(N,N-diethylamino) -1-pentyllithium, 6-(N,N-diethylamino)-1-hexyllithium, 3-(N-ethyl-N-methylamino) -1-propyllithium, 3-(N-ethyl-N-methylamino)-2-methyl-1-propyl halide, 3-(N-ethyl-N-methylamino)-2,2-dimethyl-1-propyl halide, 4-(N-ethyl-N-methylamino)-1-butyllithium, 5-(N-ethyl-N-methylamino)-1-pentyllithium, 6-(N-ethyl-N-methylamino) -1-hexyllithium, 3-(piperidino)-1-propyllithium, 3-(piperidino)-2-methyl-1-propyllithium, 3-(piperidino)-2,2-dimethyl-1-propyllithium, 4-(piperidino)-1-butyllithium, 5-(piperidino)-1-pentyllithium, 6-(piperidino)-1-hexyllithium, 3-(pyrrolidino)-1-propyllithium, 3-(pyrrolidino)-2-methyl-1-propyllithium, 3-(pyrrolidino)-2,2-dimethyl-1-propyllithium, 4-(pyrrolidino)-1-butyllithium, 5-(pyrrolidino)-1-pentyllithium, 6-(pyrrolidino)-1-hexyllithium, 3-(hexamethyleneimino)-1-propyllithium, 3-(hexamethyleneimino)-2-methyl-1-propyllithium, 3-(hexamethyleneimino)-2,2-dimethyl -1-propyllithium, 4-(hexamethyleneimino)-1-butyllithium, 5-(hexamethyleneimino)-1-pentyllithium, 6-(hexamethyleneimino)-1-hexyllithium, 3-(2,2,5,5-tetramethyl-2,5-disila -1-azacyclopentane)-1-propyllithium, 4-(2,2,5,5-tetramethyl-2,5-disila-1-azacyclopentane)-1-butyllithium, 6-(2,2,5,5-tetramethyl-2,5-disila-1-azacyclopentane)-1-hexyllithium, 3-(N-isopropyl-N-methyl)-1-propyllithium, 2-(N-isopropyl-N-methyl)-2-methyl-1-propyllithium, 3-(N-isopropyl-N-methyl)-2,2-dimethyl-1-propyllithium, and 4-(N-isopropyl-N-methyl)-1-butyllithium, 3-(methylthio)-1-propyllithium, 3-(methylthio) -2-methyl-1-propyllithium, 3-(methylthio)-2,2-dimethyl-1-propyllithium, 4-(methylthio) -1-butyllithium, 5-(methylthio)-1-pentyllithium, 6-(methylthio)-1-hexyllithium, 8-(methylthio)-1-octyllithium, 3-(methoxymethylthio)-1-propyllithium, 3-(methoxymethylthio)-2-methyl-1-propyllithium, 3-(methoxymethylthio)-2,2-dimethyl-1-propyllithium, 4-(methoxymethylthio)-1-butyllithium, 5-(methoxymethylthio)-1-pentyllithium, 6-(methoxymethylthio)-1-hexyllithium, 8-(methoxymethylthio)-1-octyllithium, 3-(1,1-dimethylethylthio)-1-propyllithium, 3-(1,1-dimethylethylthio)-2-methyl-1-propyllithium, 3-(1,1-dimethylethylthio)-2,2-dimethyl-1-propyllithium, 4-(1,1-dimethylethylthio)-1-butyllithium, 5-(1,1-dimethylethylthio)-1-pentyllithium, 6-(1,1-dimethylethylthio)-1-hexyllithium, 8-(1,1-dimethylethylthio)-1-octyllithium, 3-(1,1-dimethylpropylthio)-1-propyllithium, 3-(1,1-dimethylpropylthio)-2-methyl-1-propyllithium, 3-(1,1-dimethylpropylthio)-2,2-dimethyl-1-propyllithium, 4-(1,1-dimethylpropylthio)-1-butyllithium, 5-(1,1-dimethylpropylthio)-1-pentyllithium, 6-(1,1-dimethylpropylthio)-1-hexyllithium, 8-(1,1-dimethylpropylthio)-1-octyllithium, 3-(cyclopentylthio)-1-propyllithium, 3-(cyclopentylthio)-2-methyl-1-propyllithium, 3-(cyclopentylthio)-2,2-dimethyl-1-propyllithium, 4-(cyclopentylthio)-1-butyllithium, 5-(cyclopentylthio)-1-pentyllithium, 6-(cyclopentylthio)-1-hexyllithium, 8-(cyclopentylthio)-1-octyllithium, 3-(cyclohexylthio)-1-propyllithium, 3-(cyclohexylthio) -2-methyl-1-propyllithium, 3-(cyclohexylthio)-2,2-dimethyl-1-propyllithium, 4-(cyclohexylthio)-1-butyllithium, 5-(cyclohexylthio)-1-pentyllithium, 6-(cyclohexylthio) -1-hexyllithium, 8-(cyclohexylthio)-1-octyllithium, 3-(t-butyldimethylsilylthio)-1-propyllithium, 3-(t-butyldimethylsilylthio)-2-methyl-1-propyllithium, 3-(t-butyldimethylsilylthio) -2,2-dimethyl-1-propyllithium, 3-(t-butyldimethylsilylthio)-2-methyl-1-propyllithium, 4-(t-butyldimethylsilylthio)-1-butyllithium, 6-(t-butyldimethylsilylthio) -1-hexyllithium and 3-(trimethylsilylthio)-2,2-dimethyl-1-propyllithium, chain extended analogs thereof and mixtures thereof.

21. The process of claim 1, wherein said organometallic compound is present in an amount ranging from about 0.001 mol % to less than about 10 mol %, based on the amount of lithiated species present.

22. The process of claim 1, wherein said organometallic compound is present in an amount ranging from about 1 to about 7 mol %, based on the amount of lithiated species present.

23. The process of claim 1, wherein said composition comprises a hydrocarbon solvent selected from the group consisting of alkanes, cycloalkanes and aromatic solvents and mixtures thereof.

24. The process of claim 1, further comprising:
reacting the thermally stabilized living polymer anion with a functionalizing agent to form a polymer having at least one terminal functional group; and
optionally reacting said at least one terminal functional group with one or more comonomers to form a polymer segment.

25. The process of claim 1, further comprising linking the thermally stabilized living polymer anions with a linking agent to form a star or multi-branched polymer.

26. A polymer composition comprising one or more anionically polymerized functionalized living polymers and at least one organometallic compound capable of forming an ate complex with an alkyllithium species in an amount less than about 10 mol %, based on the amount of lithiated species present, so as to thermally stabilize said living polymer anions without significantly inhibiting the reactivity of the lithiated species.

27. The composition of claim 26, wherein said organometallic compound is soluble in hydrocarbon solvents.

28. The composition of claim 26, wherein said organometallic compound is a compound of the formula MetR′hd n, wherein:
Met is a metal selected from Group IIA, Group IIB, and Group III of the Periodic Table of Elements;
each R′ is independently selected from C₁-C₂₀ aliphatic hydrocarbons, C₂-C₂₀ cycloaliphatic hydrocarbons, C₅-C₂₀ aromatic hydrocarbons, and mixtures thereof; and
n is the valence of Met.

29. The composition of claim 28, wherein said organometallic compound is a compound of the formula M¹R²⁰R²¹, wherein:
M¹ is an element of Group IIA or Group IIB; and
each R²⁰ and R²¹ is selected from the group consisting of C₁-C₂₀ aliphatic hydrocarbons, C₂-C₂₀ cycloaliphatic hydrocarbons, C₅-C₂₀ aromatic hydrocarbons, and mixtures thereof.

30. The composition of claim 29, wherein M¹ is selected from the group consisting of beryllium, magnesium, calcium, strontium, barium, radium, zinc, cadmium, and mercury.

31. The composition of claim 30, wherein M¹ is magnesium.

32. The composition of claim 30, wherein M¹ is zinc.

33. The composition of claim 28, wherein said organometallic compound is a compound of the formula M²R²³R²⁴R²⁵, wherein:
M² is an element of Group III; and
each R²³, R²⁴, and R²⁵ is selected from the group consisting of C₁-C₂₀ aliphatic hydrocarbons, C₂-C₂₀ cycloaliphatic hydrocarbons, C₅-C₂₀ aromatic hydrocarbons, and mixtures thereof.

34. The composition of claim 33, wherein M² is selected from the group consisting of boron, aluminum, gallium, indium, and thallium.

35. The composition of claim 34, wherein M² is aluminum.

36. The composition of claim 26, wherein said organometallic compound is selected from the group consisting of diethylmagnesium, diisopropylmagnesium, dibutylmagnesium, dicyclohexylmagnesium, diphenylmagnesium, diethylzinc, dibutylzinc, diphenyl zinc, triethylaluminum, tripropylaluminum, triisopropylaluminum, tributylaluminum, trioctylaluminum, trimethylboron, triethylboron, and tributylboron and mixtures thereof.

37. The composition of claim 26, wherein said functionalized alkyllithium initiator comprises a compound of the formula
Li—Qₙ—Z—T—(A—R₁₀R₁₁R₁₂)ₘ
and 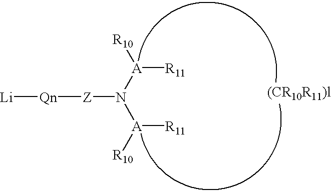
wherein:
Q is an unsaturated hydrocarbyl group derived by incorporation of one or more conjugated diene hydrocarbons, one or more alkenylaromatic compounds, or mixtures of one or more dienes with one or more alkenylaromatic compounds into the M—Z linkage;
n is from 0 to 5;
Z is a branched or straight chain hydrocarbon connecting group which contains 3-25 carbon atoms, optionally substituted with C₅-C₂₅ aryl or substituted C₅-C₂₅ aryl;
T is selected from the group consisting of oxygen, sulfur, and nitrogen groups and mixtures thereof;
(A—R₁₀R₁₁R₁₂)ₘ is a protecting group in which A is an element selected from Group IVa of the Periodic Table of the Elements, and R₁₀, R₁₁, and R₁₂ are each independently selected from the group consisting of hydrogen, C₁-C₁₅ alkyl, substituted C₁-C₁₅ alkyl, C₅-C₂₅ aryl, substituted C₅-C₂₅ aryl, C₅-C₁₂ cycloalkyl and substituted C₅-C₁₂ cycloalkyl;
l is an integer from 1 to 7; and
m is 1 when T is oxygen or sulfur, and 2 when T is nitrogen.

38. The composition of claim 37, wherein A is carbon.

39. The composition of claim 38, wherein T is nitrogen.

40. The composition of claim 38, wherein T is oxygen.

41. The composition of claim 38, wherein said organometallic compound is dibutylmagnesium.

42. The composition of claim 37, wherein A is silicon.

43. The composition of claim 42, wherein said functionalized alkyllithium is 3-trimethylsilyloxy-1-propyllithium.

44. The composition of claim 42, wherein said functionalized alkyllithium is 2,2-dimethyl-3-trimethylsilyloxy-1-propyllithium.

45. The composition of claim 37, wherein said functionalized alkyllithium initiator is selected from the group consisting of 3-(t-butyldimethylsilyloxy)-1-propyllithium, 3-(t-butyldimethyl-silyloxy)-2-methyl-1-propyllithium, 3-(t-butyldimethylsilyloxy) -2,2-dimethyl-1-propyllithium, 4-(t-butyldimethylsilyloxy)-1-butyllithium, 5-(t-butyldimethyl-silyloxy)-1-pentyllithium, 6-(t-butyldimethylsilyloxy)-1-hexyllithium, 8-(t-butyldimethylsilyloxy)-1-octyllithium, 3-(t-butyldiphenylsilyloxy)-1-propyllithium, 3-(t-butyldiphenylylsiloxy)-2-methyl-1-propyllithium, 3-(t-butyldiphenylsilyloxy) -2,2-dimethyl-1-propyllithium, 6-(t-butyldiphenylsilyloxy)-1-hexyllithium, 3-(triisopropylsilyloxy)-1-propyllithium, 3-(trimethylsilyloxy)-2,2-dimethyl-1-propyllithium, 3-(triethylsilyloxy)-2,2-dimethyl-1-propyllithium, 3-(1,1-dimethylethoxy)-1-propyllithium, 3-(1,1-dimethylethoxy)-2-methyl-1-propyllithium, 3-(1,1-dimethylethoxy)-2,2-dimethyl-1-propyllithium, 4-(1,1-dimethylethoxy)-1-butyllithium, 5-(1,1-dimethylethoxy)-1-pentyllithium, 6-(1,1-dimethylethoxy)-1-hexyllithium, 8-(1,1-dimethylethoxy)-1-octyllithium, 3-(1,1-dimethylpropoxy)-1-propyllithium, 3-(1,1-dimethylpropoxy)-2-methyl-1-propyllithium, 3-(1,1-dimethylpropoxy)-2,2-dimethyl-1-propyllithium, 4-(1,1-dimethylpropoxy)-1-butyllithium, 5-(1,1-dimethylpropoxy)-1-pentyllithium, 6-(1,1-dimethylpropoxy)-1-hexyllithium, 8-(1,1-dimethylpropoxy)-1-octyllithium, 4-(methoxy)-1-butyllithium, 4-(ethoxy)-1-butyllithium, 4-(n-propyloxy)-1-butyllithium, 4-(1-methylethoxy)-1-butyllithium, 3-[3-(dimethylamino)-1-propyloxy]-1-propyllithium, 3-[2-(dimethylamino) -1-ethoxy]-1-propyllithium, 3-[2-(diethylamino)-1-ethoxy]-1-propyllithium, 3-[2-(diisopropyl)amino)-1-ethoxy]-1-propyllithium, 3-[2-(1-piperidino)-1-ethoxy]-1-propyllithium, 3-[2-(1-pyrrolidino)-1-ethoxy]-1-propyllithium, 4-[3-(dimethylamino)-1-propyloxy]-1-butyllithium, 6-[2-(1-piperidino)-1-ethoxy]-1-hexyllithium, 3-[2-(methoxy)-1-ethoxy]-1-propyllithium, 3-[2-(ethoxy)-1-ethoxy]-1-propyllithium, 4-[2-(methoxy)-1-ethoxy]-1-butyllithium, 5-[2-(ethoxy)-1-ethoxy]-1-pentyllithium, 3-[3-(methylthio)-1-propyloxy]-1-propyllithium, 3-[4-(methylthio)-1-butyloxy]-1-propyllithium, 3-(methylthiomethoxy)-1-propyllithium, 6-[3-(methylthio)-1-propyloxy]-1-hexyllithium, 3-(N,N-dimethylamino)-1-propyllithium, 3-(N,N-dimethylamino)-2-methyl-1-propyllithium, 3-(N,N-dimethylamino)-2,2-dimethyl-1-propyllithium, 4-(N,N-dimethylamino) -1-butyllithium, 5-(N,N-dimethylamino)-1-pentyllithium, 6-(N,N-dimethylamino) -1-hexyllithium, 3-(N,N-diethylamino)-1-propyllithium, 3-(N,N-diethylamino) -2-methyl-1-propyllithium, 3-(N,N-diethylamino)-2,2-dimethyl-1-propyllithium, 4-(N,N-diethylamino)-1-butyllithium, 5-(N,N-diethylamino)-1-pentyllithium, 6-(N,N-diethylamino)-1-hexyllithium, 3-(N-ethyl-N-methylamino)-1-propyllithium, 3-(N-ethyl-N-methylamino)-2-methyl-1-propyl halide, 3-(N-ethyl-N-methylamino) -2,2-dimethyl-1-propyl halide, 4-(N-ethyl-N-methylamino)-1-butyllithium, 5-(N-ethyl-N-methylamino)-1-pentyllithium, 6-(N-ethyl-N-methylamino)-1-hexyllithium, 3-(piperidino)-1-propyllithium, 3-(piperidino)-2-methyl-1-propyllithium, 3-(piperidino)-2,2-dimethyl-1-propyllithium, 4-(piperidino)-1-butyllithium, 5-(piperidino) -1-pentyllithium, 6-(piperidino)-1-hexyllithium, 3-(pyrrolidino)-1-propyllithium, 3-(pyrrolidino)-2-methyl-1-propyllithium, 3-(pyrrolidino)-2,2-dimethyl-1-propyllithium, 4-(pyrrolidino)-1-butyllithium, 5-(pyrrolidino)-1-pentyllithium, 6-(pyrrolidino)-1-hexyllithium, 3-(hexamethyleneimino)-1-propyllithium, 3-(hexamethyleneimino)-2-methyl-1-propyllithium, 3-(hexamethyleneimino)-2,2-dimethyl-1-propyllithium, 4-(hexamethyleneimino)-1-butyllithium, 5-(hexamethyleneimino)-1-pentyllithium, 6-(hexamethyleneimino)-1-hexyllithium, 3-(2,2,5,5-tetramethyl-2,5-disila-1-azacyclopentane)-1-propyllithium, 4-(2,2,5,5-tetramethyl-2,5-disila-1-azacyclopentane) -1-butyllithium, 6-(2,2,5,5-tetramethyl-2,5-disila-1-azacyclopentane)-1-hexyllithium, 3-(N-isopropyl-N-methyl)-1-propyllithium, 2-(N-isopropyl-N-methyl)-2-methyl-1-propyllithium, 3-(N-isopropyl-N-methyl)-2,2-dimethyl-1-propyllithium, and 4-(N-isopropyl-N-methyl) -1-butyllithium, 3-(methylthio)-1-propyllithium, 3-(methylthio)-2-methyl-1-propyllithium, 3-(methylthio)-2,2-dimethyl-1-propyllithium, 4-(methylthio)-1-butyllithium, 5-(methylthio)-1-pentyllithium, 6-(methylthio)-1-hexyllithium, 8-(methylthio)-1-octyllithium, 3-(methoxymethylthio)-1-propyllithium, 3-(methoxymethylthio)-2-methyl-1-propyllithium, 3-(methoxymethylthio)-2,2-dimethyl-1-propyllithium, 4-(methoxymethylthio)-1-butyllithium, 5-(methoxymethylthio)-1-pentyllithium, 6-(methoxymethylthio)-1-hexyllithium, 8-(methoxymethylthio)-1-octyllithium, 3-(1,1-dimethylethylthio)-1-propyllithium, 3-(1,1-dimethylethylthio)-2-methyl-1-propyllithium, 3-(1,1-dimethylethylthio)-2,2-dimethyl-1-propyllithium, 4-(1,1-dimethylethylthio)-1-butyllithium, 5-(1,1-dimethylethylthio)-1-pentyllithium, 6-(1,1-dimethylethylthio)-1-hexyllithium, 8-(1,1-dimethylethylthio)-1-octyllithium, 3-(1,1-dimethylpropylthio)-1-propyllithium, 3-(1,1-dimethylpropylthio)-2-methyl-1-propyllithium, 3-(1,1-dimethylpropylthio)-2,2-dimethyl-1-propyllithium, 4-(1,1-dimethylpropylthio)-1-butyllithium, 5-(1,1-dimethylpropylthio)-1-pentyllithium, 6-(1,1-dimethylpropylthio)-1-hexyllithium, 8-(1,1-dimethylpropylthio)-1-octyllithium, 3-(cyclopentylthio)-1-propyllithium, 3-(cyclopentylthio)-2-methyl-1-propyllithium, 3-(cyclopentylthio)-2,2-dimethyl-1-propyllithium, 4-(cyclopentylthio)-1-butyllithium, 5-(cyclopentylthio)-1-pentyllithium, 6-(cyclopentylthio)-1-hexyllithium, 8-(cyclopentylthio)-1-octyllithium, 3-(cyclohexylthio)-1-propyllithium, 3-(cyclohexylthio) -2-methyl-1-propyllithium, 3-(cyclohexylthio)-2,2-dimethyl-1-propyllithium, 4-(cyclohexylthio)-1-butyllithium, 5-(cyclohexylthio)-1-pentyllithium, 6-(cyclohexylthio) -1-hexyllithium, 8-(cyclohexylthio)-1-octyllithium, 3-(t-butyldimethylsilylthio)-1-propyllithium, 3-(t-butyldimethylsilylthio)-2-methyl-1-propyllithium, 3-(t-butyldimethylsilylthio) -2,2-dimethyl-1-propyllithium, 3-(t-butyldimethylsilylthio)-2-methyl-1-propyllithium, 4-(t-butyldimethylsilylthio)-1-butyllithium, 6-(t-butyldimethylsilylthio) -1-hexyllithium and 3-(trimethylsilylthio)-2,2-dimethyl-1-propyllithium, chain extended analogs thereof and mixtures thereof.

46. The composition of claim 26, wherein said organometallic compound is present in an amount ranging from about 0.001 mol % to less than about 10 mol %, based on the amount of lithiated species present.

47. The composition of claim 26, wherein said organometallic compound is present in an amount ranging from about 1 to about 7 mol %, based on the amount of lithiated species present.

48. The composition of claim 26, wherein said composition comprises a hydrocarbon solvent selected from the group consisting of alkanes, cycloalkanes and aromatic solvents and mixtures thereof.
